(19) United States
(12) Patent Application Publication
(10) Pub. No.: US 2015/0241340 A1
(43) Pub. Date: Aug. 27, 2015

(54) MEASUREMENT APPARATUS AND MEASUREMENT METHOD

(71) Applicant: CANON KABUSHIKI KAISHA, Tokyo (JP)

(72) Inventors: Oichi Kubota, Kawasaki-shi (JP); Sayuri Yamaguchi, Tokyo (JP)

(21) Appl. No.: 14/620,872

(22) Filed: Feb. 12, 2015

(30) Foreign Application Priority Data
Feb. 22, 2014 (JP) 2014-032375
Feb. 5, 2015 (JP) 2015-020820

(51) Int. Cl. G01N 21/3581

(52) U.S. Cl. CPC G01N 21/3581; G01N 2201/06113; G01N 2201/12

(57) ABSTRACT

A measurement apparatus configured to discriminate a substance constituting a specimen through use of a terahertz wave, which includes: a radiation unit configured to radiate a terahertz wave to the specimen; a detection unit configured to detect the terahertz wave transmitted through or reflected by the specimen; a spectrum acquisition unit configured to acquire a measurement spectrum through use of a detection result of the detection unit; a structure acquisition unit configured to acquire information relating to a size of a structure of the specimen; and a discrimination unit configured to discriminate a substance constituting the specimen through use of the measurement spectrum and a plurality of spectra, the discrimination unit being configured to set, based on the information, a frequency range of the measurement spectrum to be used for the discrimination of the substance of the specimen.

### BACKGROUND OF THE INVENTION

1. Field of the Invention

The present invention relates to a measurement apparatus and a measurement method for measuring a specimen through use of terahertz waves.

2. Description of the Related Art

In recent years, there have been developed various testing technologies using electromagnetic waves having a frequency covering the range of from 30 GHz or more to 30 THz or less, which are so-called terahertz waves. In Japanese Patent Application Laid-Open No. 2011-112548, there is disclosed a technology for obtaining the refractive index and the like of a specimen surface by analyzing the reflected light of terahertz waves irradiated on the specimen, and visualizing the result in two dimensions. Further, in Japanese Patent No. 5291983, there is disclosed a technology for visualizing for a limited frequency an intensity distribution of terahertz waves transmitted through a specimen. Those technologies have features in utilizing the transmittance properties of terahertz waves, and in investigating the distribution of optical properties of the specimen while maintaining a high resolution regarding the shape.

On the other hand, there is also a measurement method in which the material and the like of a specimen are discriminated by measuring the optical properties of the specimen in the manner described above, and comparing the measured optical properties with optical properties obtained in advance for each material. In U.S. Patent Application Publication No. 2012/0328178, which employs this technology in the measurement of a biological specimen, there is disclosed a method of estimating the tissue of a measurement region and the state of that tissue by subjecting the measured optical properties to suitable pre-processing, and then performing multivariate analysis.

When the substances (constituent substances) constituting the specimen are discriminated from a spectrum obtained by irradiating terahertz waves onto a desired region of the specimen, the spatial resolution of the measurement apparatus affects the discrimination accuracy. The beam diameter of the terahertz waves irradiated onto the specimen acts as a rough guide of the spatial resolution. The beam diameter can be increased and decreased by changing the numerical aperture (NA) of the irradiation optical system. However, there is a limit to how much the beam diameter can be increased or decreased. The beam diameter cannot be narrowed to less than about the wavelength. Accordingly, this defines the limit of the spatial resolution of measurement using terahertz waves. For example, the wavelength of terahertz waves in the frequency range of from 300 GHz or more to 3 THz or less, which can be handled comparatively easily, corresponds to a range of from about 1 mm or more to 100 μm or less. When the size (hereinafter also referred to as “scale”) of the structure of the specimen is smaller than the spatial resolution, the discrimination accuracy of the constituent substances of the specimen using terahertz waves may degrade.

Careful analysis has also been required even when the scale of the specimen structure and the spatial resolution are about the same. This is because a comparison with a spectrum obtained in advance is difficult because the shape of the obtained spectrum changes due to the effects of the structure of the specimen. In such a case, the discrimination accuracy of the substances constituting a measurement region may degrade.

### SUMMARY OF THE INVENTION

According to the present invention, there is provided a measurement apparatus configured to discriminate a substance constituting a specimen through use of a terahertz wave, the measurement apparatus including:
a radiation unit configured to radiate a terahertz wave to the specimen;
a detection unit configured to detect the terahertz wave transmitted through or reflected by the specimen;
a spectrum acquisition unit configured to acquire a measurement spectrum through use of a detection result of the detection unit;
a structure acquisition unit configured to acquire information relating to a size of a structure of the specimen; and
a discrimination unit configured to discriminate a substance constituting the specimen through use of the measurement spectrum and a plurality of spectra,
the discrimination unit being configured to set, based on the information, a frequency range of the measurement spectrum to be used for the discrimination of the substance of the specimen.

Further aspects of the present invention will become apparent from the following description of exemplary embodiments with reference to the attached drawings.

### BRIEF DESCRIPTION OF THE DRAWINGS

FIG. 1 illustrates an overall configuration of a measurement apparatus according to a first embodiment of the present invention.

FIGS. 2A, 2B and 2C illustrate a configuration of an observation unit according to the first embodiment.

FIGS. 3A, 3B and 3C show the frequency dependence of beam diameter according to the first embodiment.

FIGS. 4A and 4B show a relationship between a structure of a specimen and measurement spectrum according to the first embodiment.

FIGS. 5A, 5B and 5C are flowcharts illustrating a measurement method according to the first embodiment.

FIGS. 6A and 6B illustrate a configuration of an observation unit according to a second embodiment of the present invention.

FIG. 7 illustrates an overall configuration of a measurement apparatus according to a third embodiment of the present invention.

FIG. 8 illustrates an overall configuration of a measurement apparatus according to a fourth embodiment of the present invention.

### DESCRIPTION OF THE EMBODIMENTS

Preferred embodiments of the present invention will now be described in detail in accordance with the accompanying drawings.

When substances (constituent substances) forming a specimen are discriminated based on measurement using terahertz waves, setting the frequency of the spectrum to be used for analysis to a wide range is advantageous for estimating the material and the state of the specimen. This is because acquiring the spectrum through use of terahertz waves having a wide frequency range means that a greater amount of information is acquired, and a greater variety of specimens can be discriminated as a range for comparing the optical properties of the specimen is wider.

However, when the spatial resolution of terahertz waves having the lowest frequency among the frequencies of the irradiated terahertz waves exceeds the size (scale) of the structure of the specimen, the discrimination accuracy of the substances constituting the specimen can degrade due to the measurement spectrum including information about a plurality of substances. To avoid this, the spatial resolution can be increased by using a band on the higher frequency side. However, in such a case, the frequency range of the terahertz waves irradiated on the specimen narrows, and hence the discrimination accuracy for a region in which the structure is uniform and in which the scale of the structure of the specimen is large is degraded.

Therefore, in the following embodiments, the frequency range of the measurement spectrum to be used for the discrimination is changed based on the measurement point of the specimen. Specifically, in the following embodiments, information is acquired relating to the size of the structure of the specimen, and the frequency range of the measurement spectrum to be used for discrimination is set through use of this information. Further, for the set measurement range, a degree of similarity with the spectrum (sample spectrum) of each of a plurality of substances or of each state of the substances acquired in advance is acquired, and a discrimination is made based on the degree of similarity with the spectra regarding which of the plurality of substances used to acquire the sample spectrum the specimen corresponds to. By configuring in this manner, the frequency range of the measurement spectrum to be used for the discrimination can be appropriately set for each measurement point, which enables the discrimination accuracy of the substances constituting the specimen to be improved even when the scale of the structure of the specimen is about the same as the spatial resolution of the measurement system.

Here, the “structure of the specimen” as used herein is defined as the combination of the substances constituting the specimen and the arrangement of those substances in the region (irradiation region) irradiated with terahertz waves on the specimen. The substances constituting the specimen are not limited to substances having different compositions. The substances constituting specimen also include substances in different states, which have the same composition but exhibit different scattering of the irradiated terahertz waves. The “size (scale) of the structure of the specimen” is the area and the like of each of one or a plurality of substances constituent the specimen in the irradiation region of the terahertz waves. In the following embodiments, as information relating to the size of the structure of the specimen, the area of each substance, the length in an arbitrary direction of each substance, or the like is acquired. For example, a case is considered in which a biological specimen is measured through use of terahertz waves having a wavelength in the frequency range of from 100 μm or more to 1 mm or less at about the same resolution. Common cells having a diameter of about 10 μm, which is less than the resolution, and tissue in which such cells are uniformly distributed, are treated as the same material.

On the other hand, if there is a separate piece of tissue having a diameter of 500 μm in the tissue in the irradiation region, the scale of the structure of the specimen is 500 μm. Cases in which abnormal tissue that has undergone changes, such as a tumor, is present in normal tissue while biologically-speaking being the same tissue, are also considered in the same manner.

The method of grasping the scale, which is described in more detail below, is carried out by calculating an amount that reflects the scale of the irradiation region of the specimen from the reflectance of visible light and image resolution.

The “degree of similarity in the spectra” quantitatively represents how much a given spectrum matches a separate spectrum. For example, a small number of characteristic values is calculated based on multivariate analysis, and a distance within a characteristic value space is taken as the degree of similarity. Alternatively, the degree of similarity may simply be a difference in optical properties between spectra for a plurality of frequencies, or a value obtained by integrating and normalizing the difference or the square of the difference over a wide frequency range. For the discrimination of the constituent substances, a method is used that statistically selects which known category a given data string belongs to. For example, pairs of the above-mentioned small number of characteristic values and categories are learned in advance, and the probability of the measurement spectrum belonging to each category is calculated. This probability may be read as the degree of similarity, and the category that obtains the highest probability value may be used as the discrimination result.

### First Embodiment

A measurement apparatus 100 (hereinafter referred to as “apparatus 100”) according to a first embodiment of the present invention is described below in detail with reference to the drawings. The apparatus 100 is a THz time-domain spectroscopy apparatus (THz-TDS apparatus) configured to radiate terahertz waves 201 onto a specimen 104, and acquire a time waveform of the terahertz waves 202 reflected by the specimen 104. The apparatus 100 is configured to acquire a measurement spectrum from the time waveform of the terahertz waves 202, and discriminate the constituent substances of the specimen through use of the measurement spectrum to display the result. First, a typical apparatus configuration is described, and then the relationship between the resolution and the measurement spectrum, the measurement and processing procedure, and the effects of the measurement and processing procedure are described.

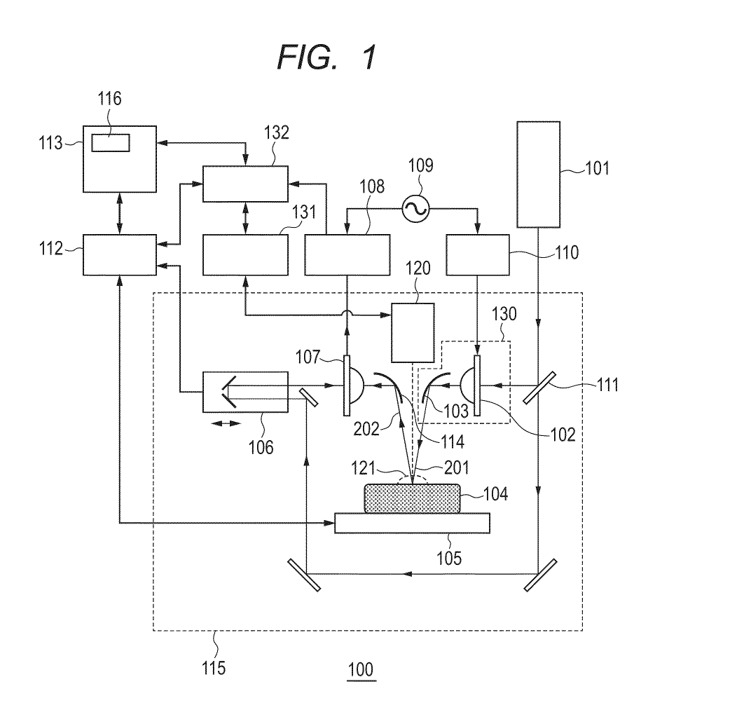

FIG. 1 illustrates the configuration of the apparatus 100. The apparatus 100 includes, in a housing 115, a stage 105, a delay unit 106, a terahertz wave detection unit 107 (hereinafter referred to as “detection unit 107”), a half mirror 111, a first focusing unit 114, an observation unit 120, and a terahertz wave radiation unit 130 (hereinafter referred to as “radiation unit 130”). The radiation unit 130 includes a terahertz wave generation unit 102 (hereinafter referred to as “generation unit 102”) and a second focusing unit 103, which is an optical system configured to focus the terahertz waves 201 and guide the terahertz waves 201 onto the specimen 104.

The apparatus 100 further includes, external to the housing 115, a light source 101, a spectrum acquisition unit 108 (hereinafter referred to as “acquisition unit 108”), an oscillator 109, a power supply 110, a control unit 112, a PC 113, a storage unit 116, a structure acquisition unit 131 (hereinafter referred to as “acquisition unit 131”), and a discrimination unit 132.

The terahertz waves 201 to be irradiated onto the specimen 104 are generated utilizing intense pulsed light in the order of femtoseconds. The intense pulsed light is output from the light source 101. Here, intense pulsed light refers to pulsed light having a pulse width in the order of femtoseconds. The light source 101 according to this embodiment outputs femtosecond laser light having a pulse width in the order of 10 femtoseconds or more to 100 femtoseconds or less (hereinafter simply referred to as “light”).

The light output from the light source 101 is split by the half mirror 111. One beam of the split light is irradiated onto the generation unit 102, and another beam is irradiated onto the detection unit 107 via the delay unit 106. The generation unit 102 is a terahertz wave source configured to generate terahertz wave pulses (hereinafter simply referred to as “terahertz wave”) due to the light entering the generation unit 102. A known photoconductive device, semiconductor, non-linear optical medium, and the like may be used for the generation unit 102. In this embodiment, a photoconductive device is used for the generation unit 102. An external voltage (hereinafter referred to as “bias voltage”) is applied by the power supply 110 on the photoconductive device. When light is irradiated onto the photoconductive device in this state, the terahertz waves 201 are generated having an intensity that is roughly proportional to the bias voltage. The generated terahertz waves 201 are focused by the focusing unit 103, and irradiated onto the surface of the specimen 104. Although various modes may be used for the focusing unit 103, a combination of a silicon lens and a parabolic mirror is typically used for a light source employing a photoconductive device.

Next, the configuration around the specimen 104 is described. The specimen 104 is placed on the stage 105 through use of a jig (not shown). The position and angle of the jig are appropriately adjusted so that an irradiation region 121 of the terahertz waves 201 on the specimen 104 matches a desired measurement point of the specimen 104. The stage 105 is configured to move the specimen 104 based on a signal from the control unit 112. By appropriately changing the relative position between the specimen 104 and the irradiation region 121, the irradiation region 121 can be set to match the desired position (measurement point) on the specimen 104. The stage 105 is configured so that light from the observation unit 120 (described below) is focused on the irradiation region 121 of the terahertz waves 201.

Note that, FIG. 1 illustrates a configuration in which the terahertz waves 201 propagating through air are directly irradiated onto the specimen 104. However, a flat plate-shaped terahertz wave transmitting member (hereinafter sometimes also referred to as “window”) may be closely attached to the specimen 104, so that the terahertz waves 201 are irradiated onto the specimen 104 through the window. The window, which fixes the specimen 104 as a part of the jig, has an effect of facilitating positioning of the measurement point.

Detection of the terahertz waves 202 reflected by the specimen 104 is performed through use of the principles of so-called time-resolved spectroscopy (THz-TDS). The terahertz waves 202 reflected by the specimen 104 are focused by the first focusing unit 114, and the intensity of the focused terahertz waves 202 is detected by the detection unit 107. Various known configurations may be employed for the detection unit 107. However, in this embodiment, a photoconductive device is used. The first focusing unit 114, which uses a parabolic mirror, and a silicon lens are used to focus the terahertz waves 202 on the detection unit 107.

The photoconductive device used as the detection unit 107 is configured to output a current that is roughly proportional to the intensity of the incident terahertz waves 202 for only the very short period of time during which light is irradiated. Because the obtained current is weak, only an effective component is extracted by phase-sensitive detection. The oscillator 109 is a supply source of periodic signals required for phase-sensitive detection. A portion of the periodic signals is output to the power supply 110 to modulate the bias voltage of the generation unit 102. Another part of the periodic signals is supplied to the acquisition unit 108, and used to extract the modulated component from the output of the detection unit 107.

The acquisition unit 108 is configured to acquire the time waveform of the terahertz waves 202 and the measurement spectrum through use of the detection result of the detection unit 107. Specifically, the acquisition unit 108 is configured to acquire the time waveform by acquiring a signal proportional to the amplitude of the terahertz waves 202 at a predetermined time in a time domain (slot) corresponding to periodic irradiation of the intense pulsed light. Further, the acquisition unit 108 is configured to calculate a frequency spectrum (hereinafter referred to as “measurement spectrum”) at the measurement point by obtaining the ratio on the frequency axis between the acquired time waveform and a time waveform acquired in advance at a reference point, and output the calculated frequency spectrum to the discrimination unit 132.

The delay unit 106 is a change unit configured to change a timing at which the terahertz waves 202 are detected by the detection unit 107. The delay unit 106 is configured to change the timing at which light is incident the detection unit 107 by controlling the light path of the light incident on the detection unit 107 from the light source 101. With this, the acquisition unit 108 can acquire the time waveform of the amplitude of the terahertz waves. The delay unit 106 may be, for example, a unit formed by mounting a reflecting mirror to the stage, or by extending or contacting an optical fiber. In addition, a method involving preparing two light sources that generate almost the same light (one light source used as a light-emitting unit, the other light source used as a detection unit), and synchronizing the laser pulses from each light source to change the emission timing may also be substituted for the delay unit 106.

Note that, a space configured to house the light-emitting unit and the detection unit and a space through which the terahertz waves propagate are provided in the housing 115, which is filled with dry air, nitrogen, or the like. Those spaces are provided to prevent the terahertz waves 201 and 202 from being absorbed by moisture during measurement, and to reduce noise included in the irradiated terahertz waves.

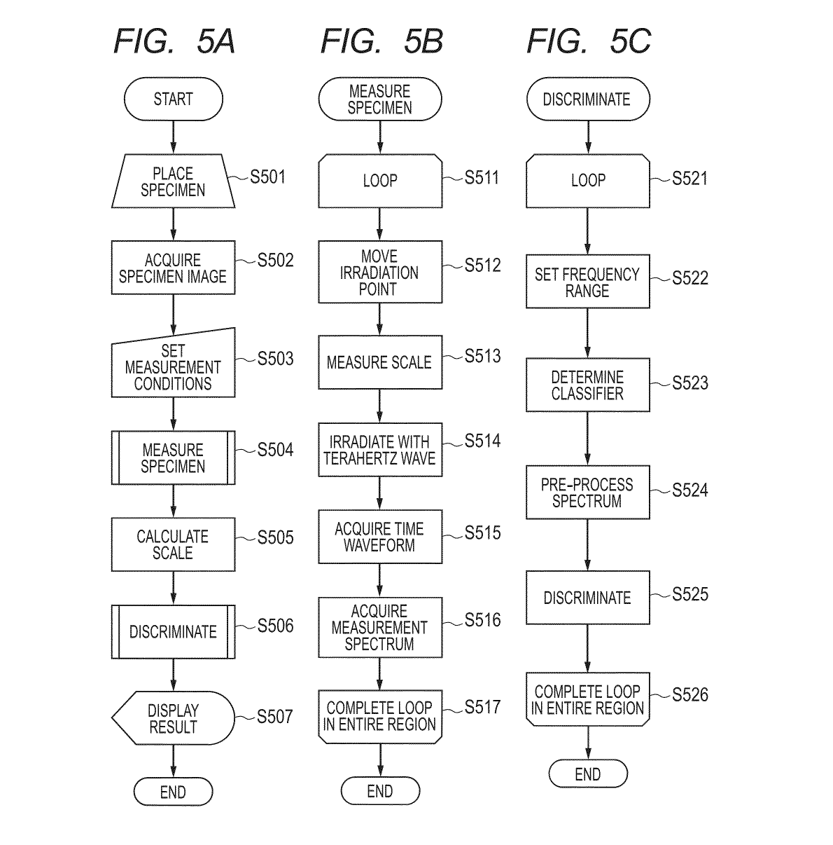

The control unit 112 is configured to control and integrate the operations of the respective units in the above-mentioned apparatus 100. The control unit 112, which is connected to a computer (PC) 113, is further configured to mediate in the reception of measurement commands and results. The PC 113 is configured to act as an interface with a measurer, for setting the measurement conditions and displaying the results. The discrimination unit 132 is configured to discriminate the constituent substances of the specimen for each measurement point by comparing the measurement spectrum acquired by the acquisition unit 108 with a plurality of sample spectra acquired in advance for each of a plurality of different materials and states. The sample data and the like for the comparison testing is stored in the storage unit 116 of the PC 113 and used as needed. Further, the storage unit 116 is configured to store a program corresponding to each step in the flowchart of the measurement method illustrated in FIGS. 5A to 5C. Processing is performed by a CPU reading and executing the program. Note that, the plurality of sample spectra are not limited to being stored in the storage unit 116, the plurality of sample spectra may also be stored on a removable storage medium, in a cloud service connected to the Internet, and the like.

The control unit 112, the acquisition unit 131, and the discrimination unit 132 are included in an arithmetic device including a processor, a memory, a storage device, an input/output device, and the like. The function of a part of those devices may also be replaced by hardware such as a logic circuit. Note that, the arithmetic device may be configured from a general-purpose computer, or may be configured from dedicated hardware such as a board computer or an ASIC. Note that, the program relating to the measurement method may also be stored in the memory of this computer. Further, the computer including the control unit 112, the acquisition unit 131, and the discrimination unit 132 and the PC 113 may be integrated.

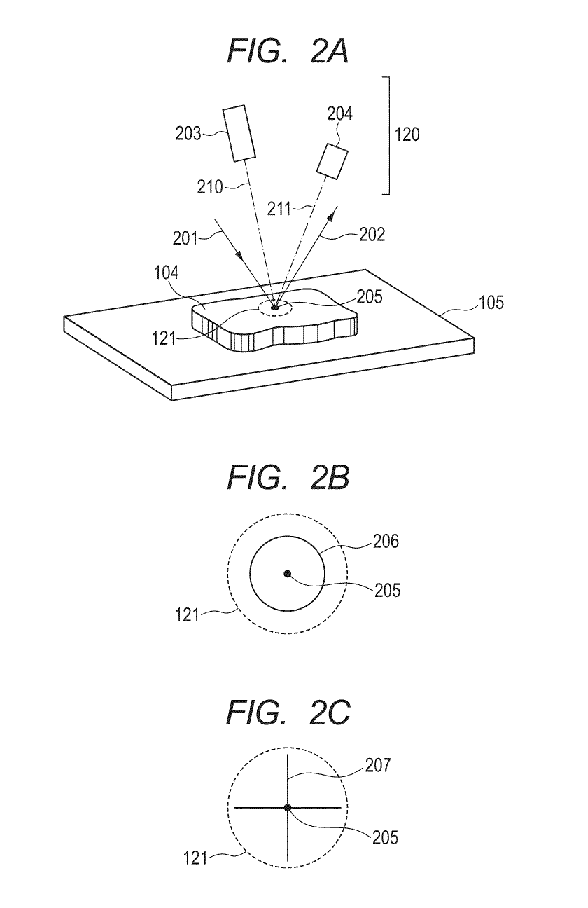

FIGS. 2A to 2C illustrate operation of the observation unit 120 according to this embodiment. The purpose of the observation unit 120 is to perform measurement for acquiring information relating to the size of the structure of the specimen in the irradiation region 121. In this embodiment, the observation unit 120 is realized by a light radiation unit 203 for observation and a light detection unit 204.

FIG. 2A illustrates the configuration of the observation unit 120. The terahertz waves 201 are irradiated onto the specimen 104 from the focusing unit 103 (see FIG. 1). The beam of the terahertz waves 201 is narrowed and adjusted so that a focal point 205 of the beam is positioned exactly on the surface of the specimen 104. On the other hand, the terahertz waves 202 reflected from the specimen 104 are focused by the focusing unit 114, and then detected by the detection unit 107 (see FIG. 1).

The observation unit 120 according to this embodiment includes the light radiation unit 203 as an observation light source and the light detection unit 204. A compact and lightweight semiconductor laser configured to emit a high-luminance laser 210 is preferred for the light radiation unit 203. The focal point of the laser 210 is adjusted so as to match the focal point 205 of the terahertz waves 201. Note that, the color (wavelength) of the laser 210 is not especially limited, but it is desired that the color be selected from the visible light region. This is because a color (wavelength) in the visible light region allows the focal point 205 of the terahertz waves 201, namely, the position of the measurement point on the specimen 104, to be observed visually, and enables the beam diameter to be easily narrowed because the wavelength is shorter than that of the terahertz waves 201.

The light detection unit 204 is configured to detect a laser 211 from the light radiation unit 203 reflected on the specimen 104, and output the intensity of the laser 211 to the acquisition unit 131 (see FIG. 1). Note that, if a specific specimen is a target, it is desired that the laser 210 be a laser including a wavelength having a higher contrast with respect to the structure of the specimen 104. Depending on the state of the specimen 104, the contrast may in some cases be insufficient, which can prevent differences from being detected. Such a case is the same as discriminating just with the terahertz waves 201.

Irradiation of the laser 210 from the light radiation unit 203 is performed at the following timing (the details of the measurement procedure are described below). First, the specimen 104 is set on the stage 105. This is performed for the purpose of confirming and adjusting the measurement position and range on the specimen 104. In this case, it is not necessary to operate the light detection unit 204. Further, the laser 210 is also irradiated onto the specimen 104 before or after the measurement is performed to acquire the measurement spectrum at each point of the specimen 104. The laser 210 is irradiated from the light radiation unit 203 toward a center point (i.e., the focal point 205) of measurement, and the laser 211 is detected by the light detection unit 204. A signal from the light detection unit 204 is analyzed by the acquisition unit 131 to acquire information relating to the scale of the structure of the specimen 104 at the irradiation region 121.

Examples of the trajectory geometry of the laser 210 irradiated by the light radiation unit 203 at this stage are illustrated in FIGS. 2B and 2C. The trajectory geometry of the laser 210 illustrated in FIG. 2B is a circle 206 centered on the focal point 205. The trajectory geometry of the laser 210 illustrated in FIG. 2C is a cross 207 intersecting at the focal point 205. A simple scanning system for changing the irradiated position of the laser 210 by oscillating a tiny mirror is incorporated in the tip of the light radiation unit 203. The above-mentioned circular and cross-shaped trajectory geometries are formed by this tiny mirror scanning spots of irradiated light. The size of the circle 206 and the cross 207 is set to be roughly the same as the irradiation region 121.

The periodic signal for scanning is transmitted to the acquisition unit 131. The acquisition unit 131 is configured to acquire information relating to the scale of the structure of the specimen 104 in the irradiation region 121 by detecting the signal of the light detection unit 204 in synchronization with the periodic signal. For example, when the laser 210 having the circle 206 as a trajectory geometry is emitted, if there is a boundary in the irradiation region 121 where two types of substance are adjacent to each other, a step is produced twice in each period of the signal output by the light detection unit 204. Further, when the laser 210 having the cross 207 as a trajectory geometry is emitted, if the laser 210 crosses the boundary, a step is produced in the output signal of the light detection unit 204. The acquisition unit 131 is configured to grasp the rough scale of the structure of the specimen 104 based on the number of steps produced in the output signal of the light detection unit 204. If the amplitude of the laser 211 can be adjusted, the scale at which the structure of the specimen 104 is uniform can be learned by gradually decreasing the amplitude of the laser 211 to find the point at which steps are eliminated from the signal.

Note that, even when the simple scanning system is not incorporated in the tip of the light radiation unit 203, almost the same effects can be obtained by moving the specimen 104 through use of the stage 105. In other words, a signal is acquired as a detection result of the light detection unit 204 while scanning the position of the focal point 205 on the specimen 104. This can be carried out in parallel with, or separately to, measurement of the measurement spectrum using the terahertz waves. Information relating to the scale of the structure of the specimen 104 is acquired by analyzing the obtained signal with the PC 113, and obtaining the number of steps produced for the irradiation region 121 of each measurement point.

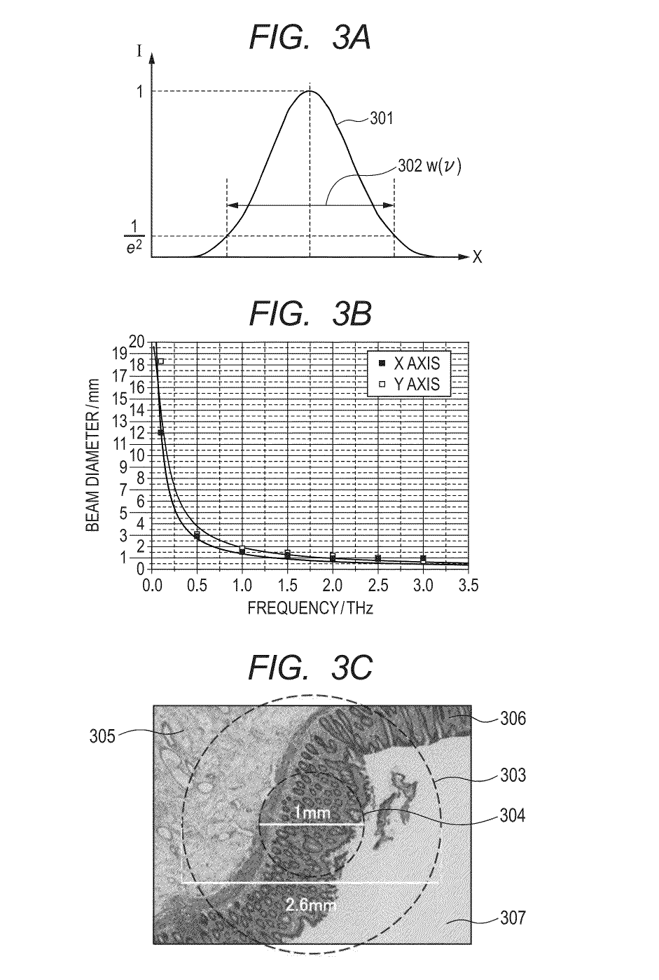

Next, the frequency dependence of the beam diameter of the terahertz waves 201 is described with reference to FIGS. 3A and 3B. FIG. 3A shows a beam profile (intensity spatial distribution) of the terahertz waves 201, which are a Gaussian beam. The abscissa indicates a position x in a cross-section of the terahertz waves 201 in a direction perpendicular to the propagation direction of the terahertz waves 201, and the ordinate indicates a normalized intensity I. The intensity distribution of the terahertz waves 201 at an arbitrary frequency ν basically follows this shape. The beam diameter is defined as, for an intensity distribution 301, a distance 302 between two points at which the intensity of the terahertz waves 201 is 1/e² of the maximum value of the intensity of the terahertz waves 201.

FIGS. 3A to 3C show an example of the beam diameter of the terahertz waves 201 at the irradiation region 121. The abscissa indicates a frequency ν (THz), and the ordinate indicates a beam diameter w (mm). Each point represents a measurement value evaluated by a knife edge method. The solid line (Y-axis) and the dotted line (X-axis) represent results fitted so as to pass through each point, based on the assumption that the beam diameter follows a Gaussian distribution. The beam diameter w at an arbitrary frequency ν depends on the structure of the optical system of the apparatus 100, and especially on the structure of the focusing unit 103. As described above, there is a limit to narrowing, and the spatial resolution is at best about the degree of the wavelength. In this example, the beam diameter w of terahertz waves having a frequency ν of 1.8 (THz) is about 1 (mm). As shown in FIG. 3B, the beam diameter w decreases as the frequency increases. In this example, the beam diameter w can be seen to undergo a large change on the lower frequency side at about a frequency ν of 0.5 (THz).

FIG. 3C shows an example in which the beam diameters at two types of frequency are displayed over an optical photograph of the specimen 104. The specimen 104 according to this embodiment is obtained by HE-dying a fixed section of human intestine as an analyte, and embedding the fixed section in paraffin 307. The specimen 104 roughly includes three regions, namely, a submucosal layer 305, a mucosal layer 306, and the paraffin 307. Here, attention is paid to the mucosal layer 306, which is known to be where adenocarcinomas are caused. The mucosal layer 306 is a thin, layer-like tissue that essentially covers the lining of an intestine. It can be seen that for the specimen 104, the mucosal layer 306 is a band-like region having a width of about 1 (mm).

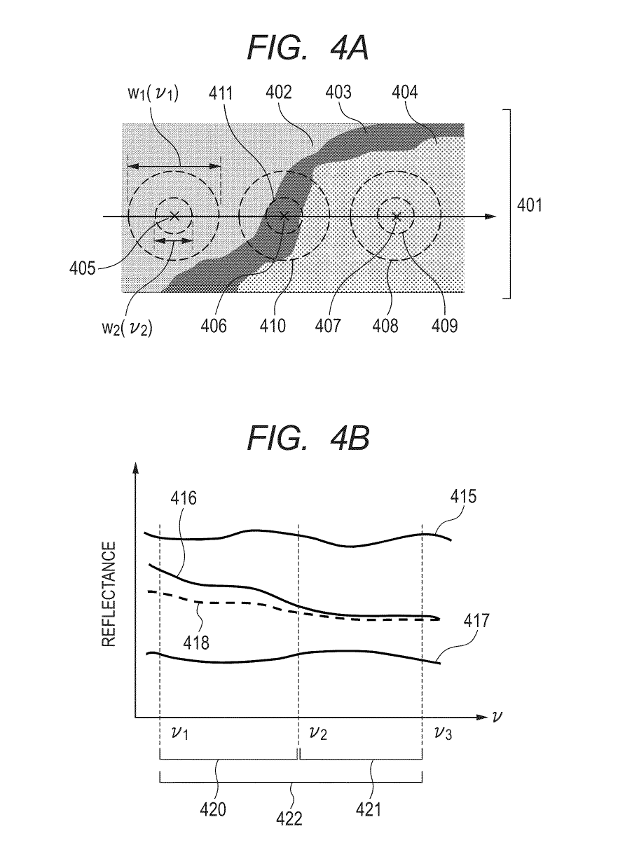

Further, FIG. 3C shows an irradiation range 303 of the terahertz waves 201 at a frequency ν of 0.5 (THz) and an irradiation range 304 of the terahertz waves 201 at a frequency ν of 1.8 (THz). The diameter of the irradiation range 303 is 2.6 (mm), and the diameter of the irradiation range 304 is 1 (mm). The irradiation range 303 includes a mixture of each of the submucosal layer 305, the mucosal layer 306, and the paraffin 307. In contrast, the irradiation range 304 only includes the mucosal layer 306. Consequently, when paying attention to the mucosal layer 306, the constituent substances of the specimen need to be discriminated through use of a measurement spectrum for an irradiation region when terahertz waves have been irradiated onto the specimen 104 having a frequency range of ν≧1.8 (THz), which is narrower than the irradiation range 304. The reason for this is because mixing of measurement spectra can occur among portions having different materials or states as the scale of the structure of the specimen 104 approaches the beam diameter. This point is described in more detail with reference to FIGS. 4A and 4B.

FIG. 4A is a schematic diagram showing a specimen 401 including three types of substance 402, 403, and 404. Points 405, 406, and 407 on the surface of the specimen 401 each represent a focal point of the terahertz waves 201 at measurement. The irradiation range of the terahertz waves 201 is shown around the points 405, 406, and 407, respectively. Irradiation ranges 409, 411, and 413 are irradiation ranges of a beam diameter w₁ at a frequency ν₁. Irradiation ranges 408, 410, and 412 are irradiation ranges of a beam diameter w₂ at a frequency ν₂. Note that, the frequency ν₂ is larger than the frequency ν₁.

FIG. 4B shows an example of a measurement spectrum obtained based on measurements at each of the points 405, 406, and 407. The abscissa of the spectrum indicates frequency, and the ordinate indicates reflectance. A measurement spectrum 415 is a reflectance spectrum acquired by irradiating the terahertz waves 201 with a focal point at the point 405. A measurement spectrum 416 is a reflectance spectrum acquired by irradiating the terahertz waves 201 with a focal point at the point 406. A measurement spectrum 417 is a reflectance spectrum acquired by irradiating the terahertz waves 201 with a focal point at the point 407. Further, a sample spectrum 418 is a reflectance spectrum of the substance 403 alone. When the focal point is at the point 407, the substance 404 is distributed uniformly across a wider range than for the irradiation range 409 at the frequency ν₁. The measurement spectrum 417 exhibits a good match with the reflectance spectrum of the substance 404 alone (not shown), and hence discrimination of the constituent substances of the irradiation range 409 is easy. This is also the same when terahertz waves are irradiated onto the irradiation range 412 with the focal point at the point 405, in which the measurement spectrum 415 exhibits a good match with the reflectance spectrum of the substance 402 alone (not shown). This is the same regardless of whether terahertz waves having the beam diameter w₁ or the beam diameter w₂ are used. Consequently, when the constituent substances of the specimen 104 are discriminated from measurement spectra acquired through use of the points 405 and 407 as the measurement points, the frequency range of the measurement spectra is widely set.

On the other hand, when the point 406 is the focal point, the situation is similar to that in the above-mentioned FIG. 3C, namely, the scale of the structure of the specimen 104 and the beam diameter (irradiation range 410) are about the same. Although the irradiation range 412 of the beam diameter w₂ only covers the region of substance 403, the irradiation range 411 of the beam diameter w₁ includes the regions of substances 402 and 404. Consequently, although the measurement spectrum 416 matches the sample spectrum 418 on a high frequency side 421 (ν₂≦ν≦ν₃), the measurement spectrum 416 diverges from the sample spectrum 418 on a low frequency side 420 (ν₁≦ν≦ν₂). One cause of this is mixing of the spectra of the respective substances with the measured reflectance spectrum 416. The ratio of this mixing is roughly proportional to the area ratio of the each substance included in the irradiation range of the beam diameter (ν). Further, the area ratio changes depending on the position of the measurement point. Consequently, the spectrum on the low frequency side is not suited to discrimination of the constituent substances of the specimen 104 when the scale of the structure of the specimen 104 is about the same as the beam diameter. In this case, discrimination needs to be carried out through use of the measurement spectrum and the sample spectrum on the high frequency side (the frequency range 421).

However, if the frequency range is limited at all of the measurement points of the specimen 104, the discrimination accuracy of the other portions of the specimen 104 decreases. Therefore, in this embodiment, information relating to the scale of the structure of the specimen 104 is acquired, and the frequency range of the measurement spectrum to be used for the discrimination is set for each measurement point based on the irradiated position of the terahertz waves 201 on the specimen 104.

Here, if terahertz waves in an arbitrary frequency range can be irradiated onto the specimen 104 during measurement, the above-mentioned spectrum mixing can be avoided by physically controlling the beam diameter. However, to enable the physical control requires adding a large-scale optical system, such as a light-emitting element, a diaphragm, an optical filter, and the like. Further, because the minimum value of the beam diameter of the terahertz waves 201 is determined based on the wavelength, in some cases the beam diameter cannot be narrowed to a desired diameter. Consequently, it is desired to, like in this embodiment, numerically select the frequency range of the measurement spectrum to which attention is being paid, without changing the frequency range of the irradiated terahertz waves. Note that, although the reflectance spectrum is used as an example of the measurement spectrum, the measurement spectrum may also be a transmittance spectrum, a refractive index spectrum, or an absorption coefficient spectrum.

Flowcharts of the measurement method according to this embodiment are illustrated in FIGS. 5A to 5C. FIG. 5A illustrates a general procedure from measurement start to finish. When the measurement range of the specimen 104 has been set, the measurement process for performing measurement while changing the position onto which terahertz waves are to be irradiated is repeated. The measurement method is illustrated in FIG. 5B. When a spectrum has been obtained for each measurement point, the obtained spectrum is compared with the spectra of each of known materials acquired in advance, and a candidate for the material corresponding to the measured specimen is estimated. This identification procedure is illustrated in FIG. 5C.

Note that, to discriminate the constituent substances of the specimen 104 through use of the measurement spectrum, it is necessary to produce and prepare a classifier in advance. The term “classifier” refers to a subroutine and the like for performing discrimination through use of a sample spectrum of each known substance acquired in advance. Although FIGS. 5A to 5C do not illustrate a method of producing the classifier, because the classifier is involved in carrying out the discrimination, the classifier is described below.

In Step S501, the specimen 104 is placed on the stage 105, and the relative positions of the specimen 104 and the irradiation region 121 are adjusted. Specifically, through use of a jig (not shown), the height and incline of the measurement surface of the specimen 104 are set at appropriate positions, and the position on a plane surface is adjusted so that a desired measurement point is at the irradiation region 121 of the terahertz waves. After adjustment has finished, an image of the surface of the specimen 104 may be captured (Step S502).

In Step S503, the measurement conditions are set, such as the type and measurement number of the specimen 104 to be measured and the type of measurement spectrum to be used for the discrimination. When an arbitrary region of the specimen 104 is measured, a range to be measured, a gap between measurement points, and the like are also set as measurement information. Those pieces of measurement information are selected by a user, and input into the PC 113. The PC 113 receives the input content, and extracts and prepares the classifier and related data to be used for identification of the measurement result from the storage unit 116. Next, in Step S504, based on the input measurement conditions, the apparatus 100 performs measurement of the specimen 104 using terahertz waves. Then, the acquisition unit 108 acquires the time waveform, and calculates the measurement spectrum by performing a Fourier transform on the obtained time waveform. Further, in Step S504, measurement of the irradiation region 121 is performed by the observation unit 120 through use of visible light. In Step S505, the acquisition unit 131 acquires information relating to the scale of the structure of the specimen 104 through use of a detection result of the light detection unit 204 of the observation unit 120. Steps S504 and S505 are carried out repeatedly until measurement of all of the measurement points specified in Step S503 has finished.

In Step S506, the discrimination unit 132 discriminates the constituent substances of the specimen 104 for each measurement point. The discrimination by the discrimination unit 132 is carried out through use of a classifier discriminated based on the measurement spectrum obtained in Step S504, the information relating to the scale of the structure of the specimen 104 obtained in Step S505, and the type of spectrum. Lastly, in Step S507, the obtained result, namely, for measurement of one point, the measurement spectrum or the discrimination result, and for measurement of an arbitrary region, a result indicating the distribution and the like of the discrimination results, is displayed, and one series of measurements is finished.

A detailed flowchart of Step S504, in which the specimen 104 is measured, is illustrated in FIG. 5B. When a region has been set to be measured, the subsequent processing is a repetitive process (Step S511). In Step S512, the control unit 112 operates the stage 105 to match the measurement point on the specimen 104 with the irradiation region 121 of the apparatus 100. Next, in Step S513, the scale of the structure of the specimen 104 in the irradiation region 121 is measured by the observation unit 120. Then, in Step S514, the radiation unit 130 irradiates the specimen 104 with the terahertz waves 201. In Step S515, the acquisition unit 108 acquires the time waveform of the terahertz waves 202 through use of the detection result of the detection unit 107.

In Step S516, the measurement spectrum is acquired through use of the time waveform of the terahertz waves 202. As the measurement spectrum, for example, a (complex amplitude) reflectance spectrum is determined based on a ratio on the frequency axis (obtained from a detection result acquired by, for example, placing a reflecting mirror in the position of the specimen 104, irradiating the reflecting mirror with the terahertz waves 201, and detecting the terahertz waves 202 reflected by the reflecting mirror) between the time waveform acquired by measurement and a reference time waveform. The refractive index spectrum and the absorption coefficient spectrum are calculated from the reflectance spectrum. In the case of measuring through a transmitting member (window), the acquisition method of the spectrum can be somewhat complex. However, first, a complex amplitude reflectance from the window to the specimen 104 is obtained, then the complex amplitude reflectance is converted into reflectance in air, and lastly the reflectance in air is converted into the refractive index spectrum and absorption coefficient spectrum. When the processing of Steps S512 to S516 has been carried out for all measurement locations, the processing leaves this loop (Step S517).

Further, FIG. 5C illustrates Step S506, in which the constituent substances at each point are discriminated, in more detail. Also in this case, when a region has been set to be measured, the subsequent processing is a repetitive process (Step S521).

In Step S522, the discrimination unit 132 discriminates the appropriate spectrum frequency range to be used for the discrimination based on the information relating to the scale of the structure of the specimen 104 previously acquired in Step S505. Next, in Step S523, the discrimination unit 132 discriminates the optimum classifier based on the type of specimen 104 and the type of spectrum to be used for the discrimination that are specified in Step S503, and the frequency range set in Step S522. In Step S524, the discrimination unit 132 performs pre-processing of the measurement spectrum. In other words, the discrimination unit 132 adapts the measurement spectrum obtained in Step S516 for identification. Specifically, values of the frequency range to be used for the discrimination are extracted from the measurement spectrum, and the values are averaged for each predetermined frequency interval to reduce the number of pieces of data. Then the data is converted into a principal component score on a principal component axis through use of related data associated with the classifier determined in Step S523.

In Step S525, the principal component score value previously obtained in Step S524 is fed into the classifier obtained in Step S523. As a result, for example, when the posterior probabilities of substances 402, 403, and 404 are, respectively, 10%, 75%, and 15%, it can be seen that the measurement spectrum has the highest degree of similarity with the spectrum of substance 403. Therefore, it can be estimated that the measurement point is most likely to be the substance 403. When the processing of Steps S522 to S525 has been carried out for all measurement locations, the processing leaves this loop (Step S526).

The classifier is now described. Various types of classifiers have been proposed as statistical methods for discriminating which known category a given data string belongs to. Here, a classifier is used that is produced from a combination of principal component analysis (PCA), which is one type of multivariate analysis, and linear discriminant analysis (LDA). PCA is used for the purpose of compressing the number of data points through feature extraction, and LDA is used for discrimination.

LDA, which requires learning beforehand when the classifier is produced, makes associations from a data string with the type or state of a substance by calculating based on a predetermined procedure a data string including a plurality of sample spectra prepared for each type or each state of substance. The conditions of the data string need to be prepared for this learning operation. Therefore, a classifier is produced in advance for each type of spectrum, each type of specimen, and each frequency range, and stored in the storage unit 116 of the PC 113. Further examples of discrimination methods include simple Bayesian classification, a support vector machine, AdaBoost and random forest, which are types of decision tree learning, artificial neural networks, and the like. The classifier is appropriately selected based on the properties of the specimen and the performance of the apparatus.

In this embodiment, the acquisition unit 131 acquires information relating to the size of the structure of the specimen 104, and through use of the acquired information, the frequency range of the measurement spectrum to be used for the discrimination is determined. This configuration enables the discrimination to be carried out in a suitable frequency range based on the scale of the structure of the specimen 104 for each measurement point, which consequently allows better discrimination accuracy than for a case in which the frequency range is not changed.

### Second Embodiment

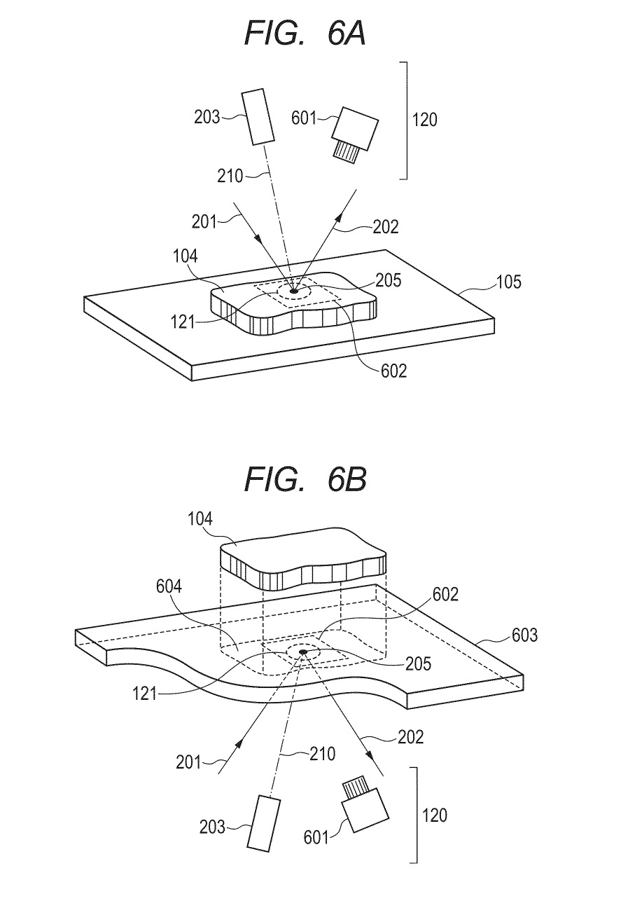

A measurement apparatus according to a second embodiment of the present invention is described with reference to FIGS. 6A and 6B. This embodiment differs from the first embodiment in terms of the configuration and operation of the observation unit 120. The other configurations are the same as for the apparatus 100. The observation unit 120 according to this embodiment includes an imaging unit 601, which is configured to capture an imaging region 602 that includes the irradiation region 121 of the specimen 104. The captured image may be monitored by the user as appropriate. The acquisition unit 131 is configured to analyze a portion corresponding to the irradiation region 121 of the image acquired by the observation unit 120, and obtain the information relating to the scale of the structure of the specimen 104. A description of the parts in the measurement apparatus according to this embodiment that are the same as in the first embodiment is omitted here.

FIG. 6A illustrates the configuration of the observation unit 120 according to this embodiment. The radiation unit 130 is configured to focus and radiate the terahertz waves 201 onto the focal point 205 on the specimen 104. The terahertz waves 202 reflected back by the irradiation region 121 pass through the focusing unit 114 and are detected by the detection unit 107.

The observation unit 120 includes the light radiation unit 203 and the imaging unit 601. The laser 210 for confirming the position of the measurement point on the specimen 104 is irradiated from the light radiation unit 203 toward the focal point 205. For example, in the step of setting the specimen 104 (Step S501) in the measurement method illustrated in FIGS. 5A to 5C, confirmation of light irradiation and position, and adjustment of the specimen position are performed.

In this embodiment, the imaging unit 601 configured to capture an image of the specimen 104 is added to the observation unit 120. A compact CCD camera, an endoscope, and the like may be used for the imaging unit 601. The imaging unit 601 is arranged in the housing 115 at a position that does not block the terahertz waves 201 and 202. An imaging range 602 of the imaging unit 601 is adjusted to include the irradiation region 121 near the focal point 205. The timing at which the imaging unit 601 captures images is controlled by the control unit 112, and the acquired images are transmitted to the acquisition unit 131.

FIG. 6B illustrates another arrangement example of the observation unit 120 and the specimen 104. The configuration illustrated in FIG. 6B is for measuring the specimen 104 through a window 603. The specimen 104 is arranged so that the window 603 and a surface to be measured (measurement surface) 604 are brought into contact with each other. The terahertz waves 201 are irradiated toward the focal point 205 on the measurement surface 604 while being focused. The terahertz waves 202 reflected back by the irradiation region 121 are detected by the detection unit 107. Similar to the configuration described above, the laser 210 is irradiated from the light radiation unit 203 toward the focal point 205 for confirmation of the measurement point. Further, the observation unit 120 is arranged in the housing 115 so that the imaging unit 601 does not block the terahertz waves 201 and 202. The range (imaging range) 602 capable of being captured by the imaging unit 601 is set so as to include the irradiation region 121 near the focal point 205. Note that, when the structure of the measurement surface 604 of the specimen can be observed from the back surface of the specimen 104, such as when the specimen 104 has a flake shape, the observation unit 120 may be arranged on the specimen 104 side with respect to the window 630.

The image capturing by the imaging unit 601 is carried out at the stage of measuring the scale in Step S513 in FIG. 5B. After the image of the imaging range 602 on the specimen 104 has been acquired by the observation unit 120, the acquisition unit 131 roughly classifies the substances based on image analysis in order to calculate area ratios in the irradiation region 121. Further, a region of interest (ROI) centered on the focal point of the terahertz waves 201 in the irradiation region 121 is set, and the area ratio of each of substances constituting the specimen 104 is examined while changing the diameter of the ROI. When a predetermined substance takes up a large part of the ROI, the diameter of the ROI at that time is taken as the information relating to the scale of the structure of the specimen 104.

Another proposal is to capture a wide range, high resolution image of the specimen surface in Step S501, cut out a ROI centered on the focal point of the irradiation region 121 from the image in Step S513, and acquire the information relating to the scale of the structure of the specimen 104 by performing similar image analysis. Further, more simply, the square root of the above-mentioned area ratios may be obtained, and used as an index that is roughly proportional to the scale of the structure of the specimen 104. Which method to use depends on the performance, processing speed, and the like of the imaging unit 601.

In this embodiment, the acquisition unit 131 acquires information relating to the size of the structure of the specimen 104, and through use of the acquired information, the frequency range of the measurement spectrum to be used for the discrimination is determined. This configuration enables the discrimination to be carried out in a suitable frequency range based on the scale of the structure of the specimen 104 for each measurement point, which consequently allows better discrimination accuracy than for a case in which the frequency range is not changed.

Further, the information relating to the scale of the structure of the specimen 104 is acquired based on an image captured by the irradiation region 121. Consequently, the irradiation region 121 can be confirmed even when it is difficult to visually observe the specimen surface and the like because the specimen 104 is housed in the housing 115. As a result, there is an advantage that measurement is easier.

### Third Embodiment

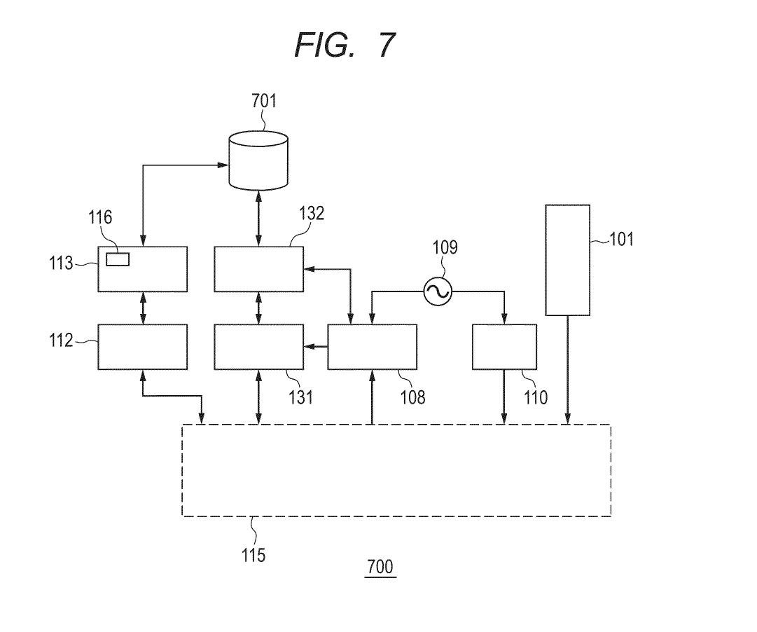

A measurement apparatus 700 (hereinafter referred to as “apparatus 700”) according to a third embodiment of the present invention is described with reference to FIG. 7. The apparatus 700 is different from the first and second embodiments in that a storage medium 701 external to the PC 113 includes a database of discrimination filters and related data as a classifier. Note that, although the internal configuration of the housing 115 is not illustrated in FIG. 7, the internal configuration is the same as in the first embodiment. The measurement apparatus according to this embodiment includes the database (DB) 701. The DB 701 is a storage medium configured to store, for each type and each state of various kinds of substances, a typical scale (typical value of the size) of the structure of each substance and a discrimination filter produced based on the scale. Further, the DB 701, which is connected to the PC 113, is configured so that the PC 113 can access desired data during measurement and analysis for discrimination of the constituent substances of the specimen 104.

The discrimination filters need to be prepared before discrimination is performed. Because there is a plurality of possible substances to be discriminated and a plurality of frequency ranges, the size of the DB 701 storing all of the discrimination filters corresponding to those may become very large. On the other hand, if the substances which become the specimen are determined, only a part of the data (discrimination filters) is required during analysis. The PC 113 extracts from the DB 701 data in the appropriate range based on a type of specimen input in Step S503, and reads the extracted data into the storage unit 116. Note that, the DB 701 is described as a unit that is integrated with the apparatus 700. However, the DB 701 may be a replaceable external storage device (medium), or may be connected via a network.

As described above, in this embodiment, a database configured to store typical values of the size of the structure of each specimen is included for each type of specimen. Further, the discrimination unit 132 is configured to set the frequency range of the measurement spectrum to be used for the discrimination of the constituent substances of the measured specimen 104 through use of information relating to the size of the structure of the specimen 104 acquired from data extracted from the database. Consequently, according to this embodiment, because the discrimination can be carried out in a frequency range suited to the scale of the structure of the specimen 104 for each measurement point, discrimination accuracy can be better than for a case in which the frequency range is not changed.

Further, through use of the large-capacity DB 701 and the storage unit 116, which is capable of high-speed access, in combination, discrimination of the constituent substances of a wide range of the specimens 104 can be carried out at a high speed. In addition, there is an advantage that discrimination filters can be easily updated and added.

In the acquisition of the information relating to the size of the structure of the specimen, the measurement result of the observation unit 120 can be used in addition to data that can be acquired from the DB 701. Further, the apparatus 700 may also be configured without including the observation unit 120, and acquire the information relating to the size of the structure of the specimen 104 from only the data that can be acquired from the DB 701.

### Fourth Embodiment

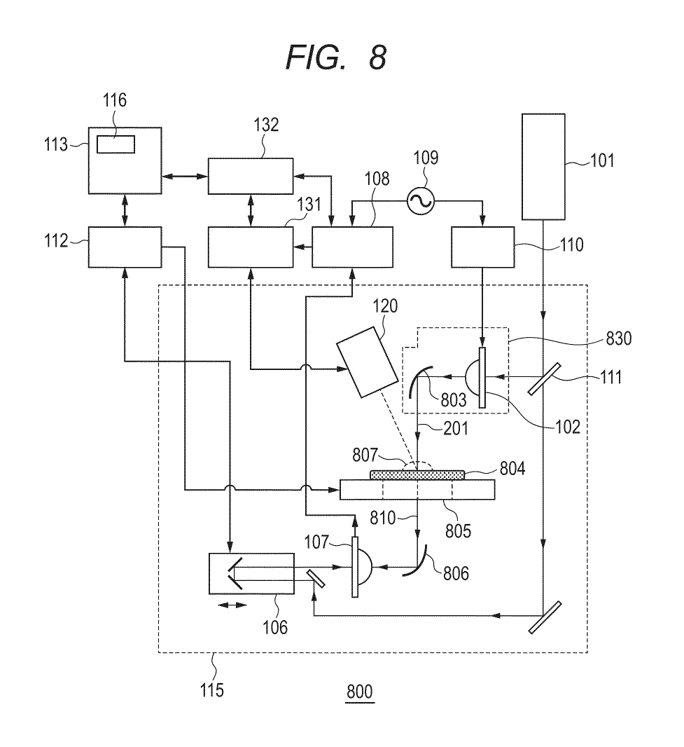

A measurement apparatus 800 (hereinafter referred to as “apparatus 800”) according to a fourth embodiment of the present invention is described with reference to FIG. 8. The above-mentioned embodiments describe the measurement apparatuses including the reflecting system that are configured to detect the terahertz waves 202 reflected by the specimen 104. In contrast, this embodiment includes a transmissive system. The terahertz waves 201 generated from the generation unit 102 are focused by a focusing unit 803 of a radiation unit 830, and irradiated onto a specimen 804. The specimen 804 is fixed on a stage 805 through use of a jig (not shown). Holes are formed in the jig, through which terahertz waves 810 that have been transmitted through the specimen 804 pass. The terahertz waves 810 that have been transmitted through the specimen 804 are focused by a focusing unit 806, and detected by the detection unit 107. Further, similar to the embodiments described above, an irradiation region 807 on the specimen 804 is observed by the observation unit 120, and through use of the observation result, the acquisition unit 131 acquires information relating to the scale of the structure of the specimen 804 in the irradiation region 807.

The specimen 804 has a flat plate shape and a smooth surface, and is formed of a substance that transmits terahertz waves well. Further, a thickness of the specimen 804 needs to have a known value or a value that is separately checked by measuring. In other words, suitable examples of the specimen according to this embodiment include specimen pieces cut to a predetermined thickness by a particular processing apparatus, specimens (including liquids) held in equal intervals by a cell-like jig, various types of substrate, and the like. In this embodiment, the transmittance spectrum of the specimen 804 is measured. Comparison and discrimination may be performed through use of the transmittance spectrum, or through use of a complex refractive index spectrum calculated using the value of the thickness of the specimen 804, namely, the refractive index spectrum of the real part and the extinction coefficient spectrum of the imaginary part.

The apparatus 800 according to this embodiment is configured so that the acquisition unit 131 acquires information relating to the size of the structure of the specimen 804, and through use of the acquired information, the frequency range of the measurement spectrum to be used for the discrimination is determined. This configuration enables the discrimination to be carried out in a suitable frequency range based on the scale of the structure of the specimen 804 for each measurement point, which consequently allows better discrimination accuracy than for a case in which the frequency range is not changed. Further, a measurement apparatus including a transmissive system configured to measure the terahertz waves 810 that have been transmitted through the specimen 804 like the apparatus 800 typically has an advantage that the accuracy of the acquired spectrum is higher than for a reflective system.

### Fifth Embodiment

Next, a fifth embodiment of the present invention is described. This embodiment is different from the embodiments described above in that an apparatus does not include the observation unit 120, and the scale of the structure of the specimen is obtained through use of the conditions input in Step S503 and the like and an output from a discrimination filter. Note that, in this embodiment, the apparatus may be configured with the observation unit 120 or without the observation unit 120. The configuration without the observation unit 120 has an advantage that the apparatus can be downsized.

In this embodiment, discrimination of measurement points for which the discrimination is difficult is carried out through use of a separate discrimination filter having a different scale. First, the type of specimen is input by the same procedure as in Step S503 of the first embodiment. Then, based on the input type, the various scales that the structure of the specimen has are grasped, and corresponding discrimination filters are prepared. Those discrimination filters may be acquired from the database according to the third embodiment. Next, the discrimination result and an estimated value of the posterior probability are obtained by processing the measured spectrum through use of the discrimination filter having the largest scale, namely, the discrimination filter having the widest frequency range of the spectrum, among the corresponding discrimination filters. When the estimated value is less than a predetermined value (e.g., 0.6=60%), it is determined that the set scale is not suitable, and the discrimination result and posterior probability are obtained in the same manner for a smaller frequency range. When a distribution measurement result is obtained, the procedure is repeated for each measurement point. When the estimated value does not exceed a predetermined value, the estimated value is processed as being impossible to discriminate (unknown). In other words, the vicinity of the measurement point has an unexpected substance or structure, or includes a boundary with a different substance.

As another mode, discrimination is carried out through use of a plurality of classifiers for all measurement points. After an exhaustive discrimination operation is performed, a substance having the maximum posterior probability for each measurement point is employed as a final discrimination result. In any case, information about a plurality of substances acquired in advance and posterior probabilities thereof are used as the information relating to the scale of the structure. Further, a configuration may also be employed in which, of the classifiers, a classifier acquired through use of the spectrum having the widest frequency range is used, and then the frequency range of the measurement spectrum is set from the posterior probability.

As yet another mode, all of the measurement spectra may be discriminated by selecting only one appropriate scale, that is, only one discrimination filter, based on the input specimen type. In this case, because differences in the scale of the structure in the specimen are ignored, although the discrimination accuracy is worse than for the embodiments described above, the configuration is simpler.

The discrimination unit 132 according to this embodiment acquires a degree of similarity between the measurement spectrum and sample spectra acquired in advance, and discriminates which sample spectrum the measurement spectrum corresponds to. In this case, the discrimination unit 132 includes a plurality of classifiers produced so as to correspond to the frequency range of the measurement spectrum to be used for the discrimination. The discrimination regarding which of the plurality of sample spectra the measurement spectrum corresponds to is performed by the plurality of discrimination units 132 having different frequency ranges acquiring indices of degree of similarity of the sample spectra and selecting a sample spectrum having high similarity. As the index of the degree of similarity, the above-mentioned posterior probability is used.

Thus, this embodiment acquires information relating to the size of the structure of the specimen from information about a plurality of substances acquired in advance and the posterior probability thereof, and through use of the acquired information, sets the frequency range of the measurement spectrum to be used for the discrimination. With such a configuration, the discrimination can be carried out in the suitable frequency range in accordance with the scale of the structure of the specimen 804 for each measurement point, which allows the discrimination accuracy to be better as compared with a case in which the frequency range is not changed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-032375, filed Feb. 22, 2014, and Japanese Patent Application No. 2015-020820, filed Feb. 5, 2015, which are hereby incorporated by reference herein in their entirety.

What is claimed is:

1. A measurement apparatus configured to discriminate a substance constituting a specimen through use of a terahertz wave, the measurement apparatus comprising:
a radiation unit configured to radiate a terahertz wave to the specimen;
a detection unit configured to detect the terahertz wave transmitted through or reflected by the specimen;
a spectrum acquisition unit configured to acquire a measurement spectrum through use of a detection result of the detection unit;
a structure acquisition unit configured to acquire information relating to a size of a structure of the specimen; and
a discrimination unit configured to discriminate a substance constituting the specimen through use of the measurement spectrum and a plurality of spectra,
the discrimination unit being configured to set, based on the information, a frequency range of the measurement spectrum to be used for the discrimination of the substance of the specimen.

2. The measurement apparatus according to claim 1, wherein the discrimination unit is configured to set the frequency range of the measurement spectrum so that an irradiation region when a terahertz wave in the frequency range is irradiated onto the specimen is equal to or less than the size of the structure of the specimen.

3. The measurement apparatus according to claim 1, further comprising an imaging unit configured to capture an image of the specimen,
wherein the structure acquisition unit is configured to acquire the information through use of an imaging result of the imaging unit.

4. The measurement apparatus according to claim 1, further comprising:
a radiation unit configured to radiate laser light onto the specimen; and
a light detection unit configured to detect the laser light transmitted through or reflected by the specimen,
wherein the structure acquisition unit is configured to acquire the information through use of a detection result of the light detection unit.

5. The measurement apparatus according to claim 1, wherein the structure acquisition unit is configured to acquire the information from a database configured to store a material of each of a plurality of substances and a typical value of a size of a structure of each of the plurality of substances.

6. The measurement apparatus according to claim 1, wherein the discrimination unit is configured to compare the measurement spectrum with each of the plurality of spectra to discriminate whether a substance used in acquisition of a spectrum that satisfies a matching condition with the measurement spectrum among the plurality of spectra is the substance constituting the specimen, and when there is no spectrum satisfying the matching condition with the measurement spectrum among the plurality of spectra, change the frequency range of the measurement spectrum.

7. The measurement apparatus according to claim 1, wherein the discrimination unit is configured to perform multivariate statistics of the measurement spectrum to extract a characteristic value of the measurement spectrum, and discriminate the constituent substance of the specimen based on the acquired characteristic value and a plurality of characteristic values of the plurality of spectra acquired in advance.

8. The measurement apparatus according to claim 7,
wherein the multivariate statistics comprises principal component analysis, and
wherein the discrimination unit is configured to discriminate the substance constituting the specimen based on a principal component score acquired by principal component analysis of the plurality of spectra and a principal component score acquired by principal component analysis of the measurement spectrum.

9. The measurement apparatus according to claim 1,
wherein the detection unit is configured to detect a terahertz wave reflected by the specimen, and
wherein the measurement spectrum and the plurality of spectra each comprise a reflectance spectrum.

10. The measurement apparatus according to claim 1,
wherein the detection unit is configured to detect a terahertz wave transmitted through the specimen, and
wherein the measurement spectrum and the plurality of spectra each comprise a transmittance spectrum.

11. The measurement apparatus according to claim 1, wherein the measurement spectrum and the plurality of spectra each comprise a complex refractive index spectrum.

12. A discrimination method for discriminating a material or a state of a specimen through use of a terahertz wave, the discrimination method comprising:
the radiation step of radiating a terahertz wave to the specimen;
the detection step of detecting the terahertz wave transmitted through or reflected by the specimen;
the spectrum acquisition step of acquiring a measurement spectrum through use of a detection result of the detection step;
the structure acquisition step of acquiring information relating to a structure of the specimen; and
the discrimination step of discriminating the material or the state of the specimen through use of the measurement spectrum and a plurality of spectra,
the discrimination step comprising setting, based on the information relating to the structure of the specimen, a frequency range of the measurement spectrum used for discrimination of a substance constituting the specimen.

13. A computer-readable storage medium having stored thereon a program for causing a computer to execute the discrimination method according to claim 12.
